(19) United States
(12) Patent Application Publication
(10) Pub. No.: US 2006/0248305 A1
(43) Pub. Date: Nov. 2, 2006

(54) Memory device having width-dependent output latency

(76) Inventors: Wayne Fang, Pleasanton, CA (US); Kishore Kasamsetty, Cupertino, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/106,230

(22) Filed: Apr. 13, 2005

(51) Int. Cl. G06F 13/00; G06F 13/28; G06F 12/00

(52) U.S. Cl. 711/167

(57) ABSTRACT

An output-width value is stored within a configuration circuit of a memory device to control the number of output drivers that are to output data from the memory device in response to a read request. An output-latency value is determined based, at least in part, on the output-width value. The output latency value is stored within the configuration circuit to control the amount of time that transpires before the output drivers are enabled to output data in response to the read request.

### FIELD OF THE INVENTION

The present invention relates to the field of high-speed signaling.

### BACKGROUND

Memory devices have traditionally been designed to have a uniform minimum output latency across various internal configurations, with finished devices tested and binned according to actual output latency. Unfortunately, maintaining uniform output latency in memory devices that have programmable data-interface widths generally means delaying device operation in faster, wider interface configurations to match the increased latency associated with narrow-width configurations. Thus, uniform-latency memory devices may be penalized by the inclusion of slower, narrow-width configurations; being binned as relatively low performance devices with correspondingly low price points, even though the narrow-width configurations may be unused.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an embodiment of a memory device having a width-dependent output latency;

FIG. 2 illustrates a more detailed embodiment of a memory device having a width-dependent output latency;

FIG. 3 illustrates a logic table illustrating an exemplary decoding operation performed by the logic decoder of FIG. 2;

FIG. 4 illustrates a narrow-path selector that may be in place of the narrow-path selector shown in FIG. 2 in an alternative embodiment;

FIG. 5 illustrates an exemplary output buffer that may be used to implement the output buffers shown in FIG. 2;

FIG. 6 illustrates an exemplary data processing system that includes a number of memory devices each having a width-dependent output latency;

FIG. 7 illustrates an exemplary sequence of operations that may be carried out within the data processing system of FIG. 6 to program the output width and output latency of the memory devices therein;

FIG. 8 illustrates an exemplary configuration register that may be included within a memory device having a width-dependent output latency; and

FIG. 9 illustrates an alternative implementation of a programmable output latency within a configuration circuit of a memory device having a width-dependent output latency.

### DETAILED DESCRIPTION

In the following description and in the accompanying drawings, specific terminology and drawing symbols are set forth to provide a thorough understanding of the present invention. In some instances, the terminology and symbols may imply specific details that are not required to practice the invention. For example, the interconnection between circuit elements or circuit blocks may be shown or described as multi-conductor or single conductor signal lines. Each of the multi-conductor signal lines may alternatively be single-conductor signal lines, and each of the single-conductor signal lines may alternatively be multi-conductor signal lines. Signals and signaling paths shown or described as being single-ended may also be differential, and vice-versa. Similarly, signals described or depicted as having active-high or active-low logic levels may have opposite logic levels in alternative embodiments. As another example, circuits described or depicted as including metal oxide semiconductor (MOS) transistors may alternatively be implemented using bipolar technology or any other technology in which a signal-controlled current flow may be achieved. Also signals referred to herein as clock signals may alternatively be strobe signals or other signals that provide event timing. With respect to terminology, a signal is said to be “asserted” when the signal is driven to a low or high logic state (or charged to a high logic state or discharged to a low logic state) to indicate a particular condition. Conversely, a signal is said to be “deasserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or deasserts, if explicitly stated or indicated by context) the signal on a signal line coupled between the signal driving and signal receiving circuits. A signal line is said to be “activated” when a signal is asserted on the signal line, and “deactivated” when the signal is deasserted. Additionally, the prefix symbol “/” attached to signal names indicates that the signal is an active low signal (i.e., the asserted state is a logic low state). A line over a signal name (e.g., ‘\overline{<signal name>}’) is also used to indicate an active low signal. The term “coupled” is used herein to express a direct connection as well as connections through one or more intermediary circuits or structures. The term “exemplary” is used herein to express an example, not a preference or requirement.

A memory device having a width-dependent output latency is disclosed herein in various embodiments, along with embodiments of data processing systems employing same. In one embodiment, the memory device includes a core memory coupled through a steering circuit to a bank of output circuits. The memory device also includes a configuration circuit that controls the number of output circuits that are enabled to output data in response to a read request, thus establishing a programmable data-interface width, referred to herein as a programmable output width or device width. The steering circuit forms different paths between the memory core and selected output circuits according to the output width, with the paths exhibiting different latencies according to their RC characteristics and relative numbers of in-path circuit elements. In one embodiment, the memory device includes control circuitry to strobe data into output buffers within the output circuits at a first time if the programmed output width is wider than a threshold output width and at a second, later time if the programmed output width is narrower than the threshold output width. By this operation, the memory device exhibits a first output latency when output widths wider than the threshold width are selected and a second, longer output latency when output widths narrower than the threshold width are selected, thus enabling the memory device to be applied in low-latency wide-interface applications and longer-latency narrow-interface applications. Thus, in contrast to uniform-latency memory devices that are typically binned according to their worst-case output latency, memory devices having a width-dependent output latency may be binned as lower-latency or longer-latency memory devices according to their device width requirements in their intended application.

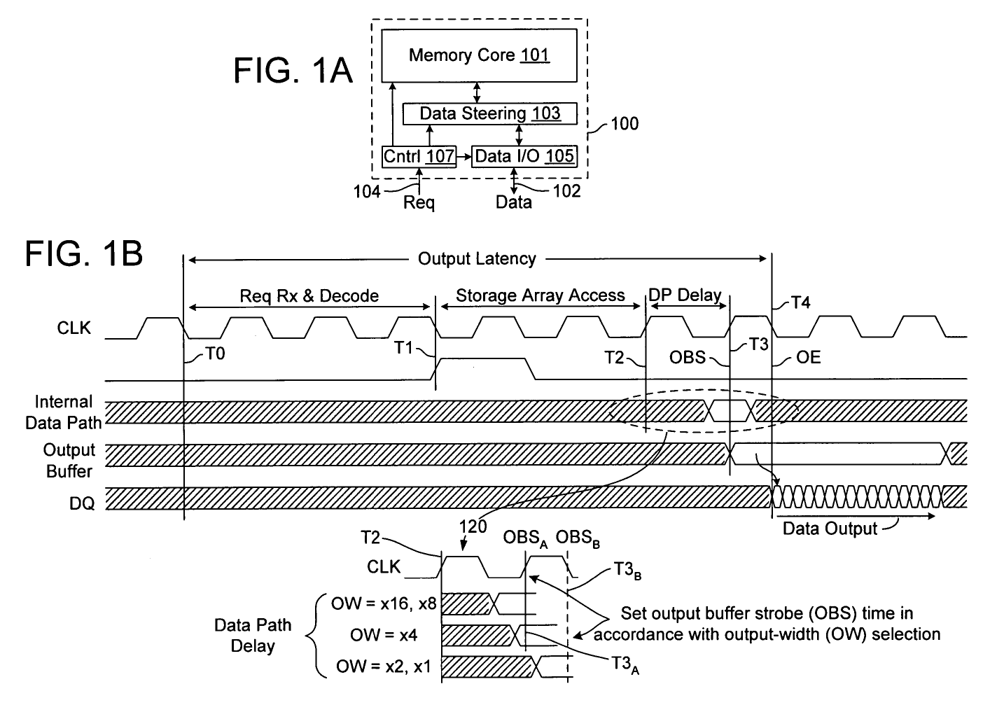

FIG. 1A illustrates an embodiment of a memory device 100 having a width-dependent output latency. The memory device 100 includes a memory core 101, steering circuit 103, data input/output (I/O) circuit 105 and control circuit 107. The data I/O circuit 105 includes a set of I/O transceivers (e.g., each transceiver including an output driver and signal receiver) coupled to receive write data (including masking information) and transmit read data via an external data path 102, and the control circuit 107 includes a set of signal receivers to receive memory access requests and device control requests (i.e., commands, instructions or any other types of requests) received via request path 104.

The control circuit 107 includes internal logic circuitry that responds to the incoming requests by issuing control and timing signals to other components of the memory device as necessary to carry out the requested operations. For example, when a read request is received within the control circuit 107, the control circuit 107 issues corresponding address information (which may be received via the request path 104, data path 102 and/or a separate address path, not shown) to decoder circuits within the memory core 101 to access address-specified storage rows and columns therein. When the core access is complete (e.g., data transferred to a page buffer of the memory core or otherwise becomes valid at output nodes of the memory core), the retrieved data is passed to the data I/O circuit 105 via the steering circuit 103, and then output onto the external data path 102. An inverse sequence of events takes place in a data write operation.

In one embodiment, the control circuit 107 includes a configuration circuit that may be programmed via the request path 104 and/or data path 102 with an output-width value and an output-latency value, as well as any other desirable control values (e.g., burst length, burst type, clock edge selection, I/O configuration, equalization settings, etc.). The output-width value specifies the number of signal transceivers within the data I/O circuit 105 that are to receive and transmit data via the external data path 102 and thus establishes the number of parallel symbols (i.e., the data width) transmitted or received by the memory device 100 in a given transfer interval. For example, in one embodiment, the output width value may be set to any of five different output-width values to establish device output widths of 16 symbols (x16), 8 symbols (x8), 4 symbols (x4), 2 symbols (x2) or 1 symbol (x1). In the x16 output width configuration, sixteen transceivers are enabled to transmit sixteen symbols onto sixteen corresponding signal links in a given transmit interval. Similarly, eight transceivers are enabled to transmit eight symbols onto eight corresponding signal links in the x8 configuration; four transceivers are enabled to transmit four symbols onto four corresponding signal links in the x4 configuration; two transceivers are enabled to transmit two symbols onto two corresponding signal links in the x2 configuration; and a single transceiver is enabled to transmit a single symbols onto a corresponding signal link in the x1 configuration. Although x16, x8, x4, x2 and x1 width selections are used in many of the examples that follow, more or fewer output widths of the same or different size may be used in alternative embodiments. Also, for simplicity, each transmitted symbol is assumed to be a binary bit, though symbols that convey more than a single bit may also be transmitted and/or received by the data I/O circuit 105 in at least one embodiment.

The output-latency value specifies the amount of time that is to transpire between receipt of a read request and output of data onto the external data path in response to the read request. As discussed below, in one embodiment, the output-latency value is programmed in accordance with the output-width value to account for incremental latency, if any, incurred in the steering circuit 103 due to the selected output width. In an alternative embodiment, the memory device interprets a given output-latency value by specifying one of at least two different output-latencies according to the programmed output-width value.

FIG. 1B is a timing diagram of an exemplary read operation within the memory device of FIG. 1A. In the particular embodiment shown, the memory device is a synchronous memory device that transfers and receives data in synchronism with an internally generated or externally supplied clock signal, CLK. For example, the clock signal may be generated by a phase-locked loop (PLL) or delay-locked loop (DLL) that obtains timing-adjust information from an incoming data stream (e.g., using clock-data recovery circuitry) or from an external timing reference such as a clock signal or strobe signal. In the example, shown, a read request is received and decoded over the time interval from T0 to T1. In one embodiment, the read request is received in multiple successive transfers over the request path (i.e., a packetized request) and may include other information associated with the read operation including, without limitation, row, column and/or bank address values. In alternative embodiments, the read request may be received in a single transfer over the request path 104, for example, with address information supplied via the data path 102, and thus may require less time than shown in FIG. 1B to receive and decode. In either case, after the read request has been decoded, the control circuit 107 issues the address information associated with the request to decode circuitry within the memory core 101 to initiate a memory core access that takes place from time T1 to time T2. For example, in a dynamic random access memory (DRAM) device, the memory core access may include a row activation operation to transfer the contents of an address-selected row of the memory core to a page buffer of the memory core (e.g., the page buffer being implemented by a bank of latching sense amplifiers), followed by a column access operation to select the column of data (i.e., a portion of the data within the page buffer) to be read. Alternatively, a DRAM device could be in a state where the row is in active state, in which case, the memory core access may include a column access operation only. At time T2, after the memory core access is complete, the data read-out from the memory core 101 (i.e., the read data) is transferred from the memory core 101 to the data I/O circuit 105 via the steering circuit 103, and thus incurs a data path delay from time T2 to time T3. At time T3, after the read data has settled at an input of the data I/O circuit 105, the control circuit 107 asserts an output buffer strobe signal (OBS) to load the data into selected output buffers within the data I/O circuit 105. Thereafter, starting at time T4, data is shifted out of the selected output buffers to form respective serial data streams that are driven onto corresponding signal links of the external data path 102.

Still referring to FIGS. 1A and 1B, in one embodiment, the memory core 101 includes sixteen separately accessible memory arrays and the data I/O circuit 105 includes a corresponding set of sixteen output buffers (i.e., output buffers for short) to enable up to sixteen serial data streams to be output from the memory device in parallel. More specifically, when the x16 output width is programmed, all sixteen output buffers are loaded in parallel to source data that is output on a 16-link external data path 102. When the x8 output width is programmed, only half of the sixteen output buffers are loaded with data and an additional address bit, referred to herein as an array-address bit, is provided in association with the read request to specify whether the upper eight or lower eight memory arrays are to be accessed. The steering circuit 103 responds to the x8 output-width selection and the array-address bit by forming a path for conducting read data from either the upper eight memory arrays or the lower eight memory arrays to the eight output buffers associated with the lower eight I/O transceivers. Thereafter, the contents of the eight loaded data buffers are output, via the transceivers, onto an 8-link external data path 102. Similarly, when the x4 output width is programmed, the steering circuit 103 conducts data from one of four groups of four memory arrays to four selected output buffers; when the x2 output width is programmed, the steering circuit 103 conducts data from one of eight pairs of memory arrays to two selected output buffers; and when the x1 output width is programmed, the steering circuit 103 conducts data from one of the sixteen memory arrays to a single selected output buffer. It should be noted that more or fewer memory arrays, output buffers and/or output width configurations may be provided in alternative embodiments.

Referring to the detail view of FIG. 1B shown at 120, as the output-width (OW) is narrowed, the data path delay increases (e.g., due to increased RC delays and in-path circuitry). In one implementation, illustrated in detail 120, the data path delay is substantially the same in the x16 and x8 modes (OW=x16, x8), but increases in the x4 mode and increases further in the x2 and x1 modes. In one embodiment, rather than delaying assertion of the output buffer strobe signal from time T3_{A} to time T3_{B} to accommodate the worst-case data path delay, the control circuit 107 is designed to assert the output buffer strobe signal at different times according to the programmed output-width. For example, in the embodiment shown at 120, the control circuit 107 asserts output buffer strobe signal (OBSA) at time T3_{A} if the programmed output width is x4 or wider, and asserts the output buffer strobe signal (OBSB) at time T3_{B} if the programmed output width is narrower than x4 (i.e., x2 or x1). As discussed below, the control circuit 107 may alternatively assert the output buffer strobe signal at both times T3_{A} and time T3_{B} if the programmed output width is narrower than x4 to buffer the desired read data in a temporary output buffer at time T3_{A}, and then in the final output buffer at time T3_{B}. Also, while the output buffer strobe signal is depicted as being delayed by a half cycle of the clock signal in detail view 120 (i.e., in response to a programmed output width narrower than x4), the output buffer strobe signal may be delayed for longer or shorter time intervals in alternative embodiments (e.g., delayed by a complete clock cycle or more, or by a smaller fraction of a clock cycle).

After the desired read data has been strobed into the selected output buffers of the data I/O circuit 105, the control circuit 107 asserts an output enable signal (OE) to enable the read data to be shifted out of the selected output buffers and output as respective serial data streams on signaling links of the external data path. In the particular embodiment shown, each data stream is a binary stream composed of sixteen bits (the quantity of read data obtained from an addressed memory array within the memory core 101) and is output at an octal symbol rate (i.e., eight symbol transfers per cycle of the clock signal). In alternative embodiments, the data stream may include more or fewer data bits, the data bits may be encoded in multi-bit symbols (e.g., each symbol conveying more than one bit of data) and/or higher or lower symbol rates may be used. Also, as discussed above, an output-latency value may be programmed within the configuration circuit to control the time at which the output enable signal is asserted. In one embodiment, the control circuit 107 automatically adjusts the output latency (i.e., the time between receipt of the read request at time T0 and data output at time T4) in accordance with the output-width value. That is, for a given output-latency value, the output enable signal is asserted at a first time if the programmed output width is greater than or equal to a threshold width, and asserted at a second, later time if the programmed output width is less than the threshold width. In an alternative embodiment, the control circuit 107 does not automatically adjust the output latency in accordance with the programmed output width. In that case, the host control circuitry (e.g., memory controller and/or processor) may be designed or programmed to determine an appropriate output-latency based on the output-width programmed (or intended to be programmed) within the memory device 100, and then program the output-latency within the memory device 100.

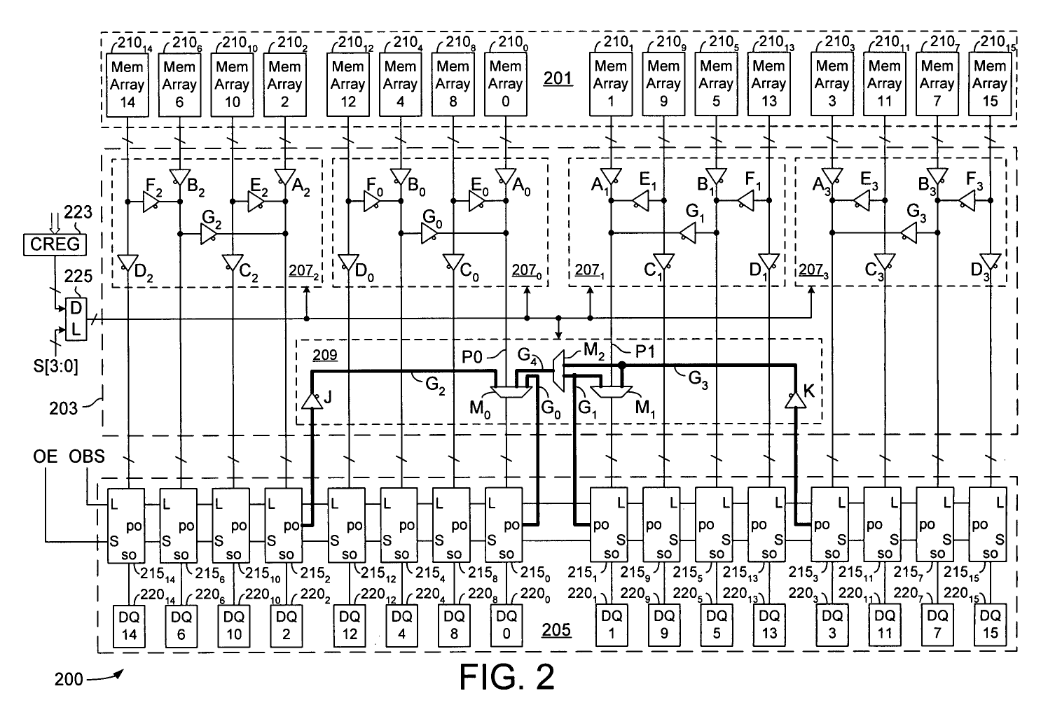

FIG. 2 illustrates a more detailed embodiment of a memory device 200 having a width-dependent output latency. The memory device 200 includes a memory core 201 having multiple separately accessible memory arrays 210₀-210₁₅; a steering circuit 203 formed by tri-state networks 207₀-207₃ and narrow-path selector 209; and a data I/O circuit 205 that includes multiple output buffers 215₀-215₁₅ and corresponding output drivers 220₀-220₁₅. The memory device 200 additionally includes a configuration register 223 (CREG) and decode logic (DL) circuit 225 that form part of a larger control circuit, not shown. Though not shown, the data I/O circuit 205 may additionally include receive circuitry to receive and buffer data transmitted via an external data interface, and the steering circuit may include additional components for steering the received data to selected memory arrays.

In one embodiment, the memory arrays 210₀-210₁₅ (referred to collectively as memory arrays 210) are DRAM arrays, though storage arrays of virtually any type may be used in alternative embodiments including, without limitation, static random access memory (SRAM) arrays and read-only memory (ROM) arrays, including electrically erasable programmable ROM (EEPROM) arrays, such as flash EEPROM. Also, while not specifically shown, the memory core may include one or more row/column decoder circuits and/or page buffers coupled to each of the memory arrays.

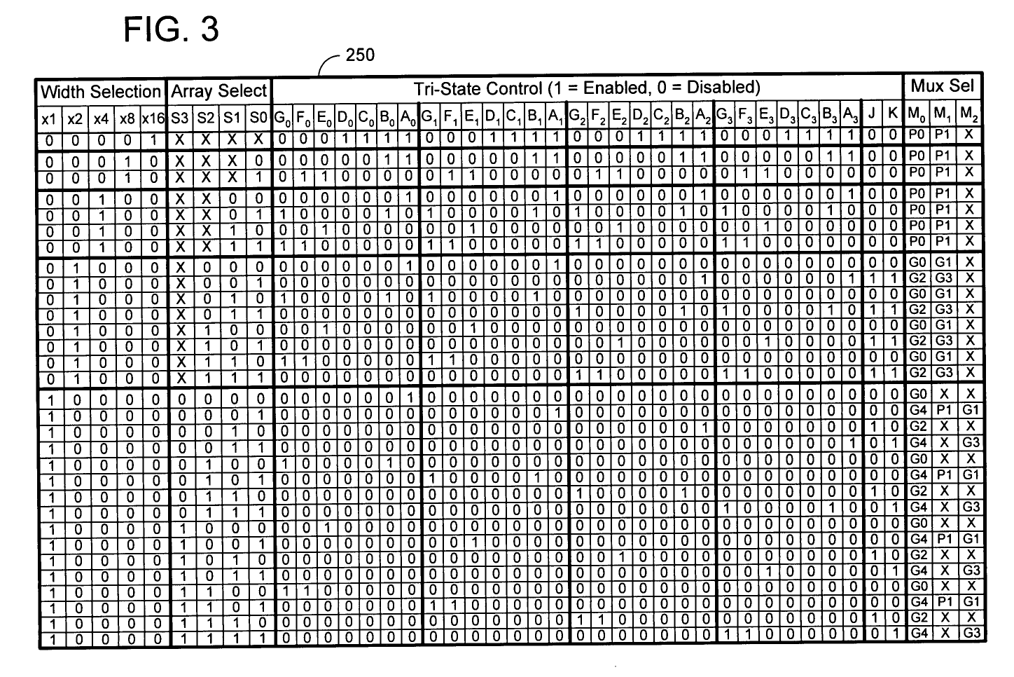

In the steering circuit 203, each of the tri-state networks 207₀-207₃ (collectively, networks 207) is provided to transfer data between a group of four memory arrays 210 and a corresponding set of four output buffers 215, and the narrow-path selector 209 is used to further refine the output buffer selection to one or two output buffers 215. More specifically, the output-width value programmed within configuration register 223 is supplied to the decode logic 225 along with a set of array-address signals, S[3:0], and used to select the output buffers 215 that are to receive read data from the memory core 201. Referring to logic table 250 of FIG. 3, which illustrates an exemplary decode operation performed by the decode logic 225, when a x16 output-width is programmed (x16=1), the array-address signals are ignored, and tri-state drivers A, B, C and D are enabled within each of the tri-state networks 207 (i.e., tri-state drivers A₀-D₀ in network 207₀, A₁-D₁ in network 207₁, A₂-D₂ in network 207₂ and A₃-D₃ in network 207₃) to transfer read data from each of the memory arrays 210₀-210₁₅ to a respective one of the output buffers 215₀-215₁₅. After delaying for a sufficient time to account for the data propagation through the tri-state networks 207 (i.e., RC delay of signal path and delay associated with a single tri-state driver), the output buffer strobe signal (OBS) is asserted to strobe the data into the output buffers 215₀-215₁₅. Shortly thereafter, the output enable signal (OE) is asserted to enable the output drivers 220₀-220₁₅ to transmit data on the external data path and to enable the contents of the output buffers 215₀-215₁₅ to be shifted forward in each transmit interval. By this arrangement, data loaded into the output buffers in parallel in response to the output buffer strobe signal is serially shifted out of the output buffers and transmitted in response to assertion of the output enable signal.

Operation in the x8 mode (i.e., x8=1) is similar to the x16 mode, except that read data is retrieved only from the lower eight or upper eight memory arrays (210₀-210₇ or 210₈-210₁₅), depending on the state of array-address bit S[0], and loaded into the lower eight output buffers 215₀-215₇. Note that the upper eight output buffers 215₈-215₁₅ may alternatively be used to buffer the read data, and that, in either case, the unused buffers may in fact be loaded with data and simply not used to source data driven onto the external data path. Referring to logic table 250 of FIG. 3, for example, the decode logic 225 enables tri-state drivers A₀-A₃ and B₀-B₃ within tri-state driver networks 207 if S[0] is low, thereby transferring data from the lower eight memory arrays 210₀-210₇ to the lower eight output buffers 215₀-215₇. If S[0] is high, the decode logic enables tri-state drivers E₀-E₃ and F₀-F₃ to transfer data from the upper eight memory arrays 210₈-210₁₅ to the lower eight output buffers 215₀-215₇. Because the number of tri-state drivers in each memory array-to-output buffer path is the same as in the x16 mode (i.e., one tri-state driver per path) and the path lengths are substantially the same, the data path delays in the x16 and x8 modes are substantially the same, so that the control circuit may assert the output buffer strobe and output enable signals at substantially the same times as in the x16 mode.

In x4 mode (x4=1), read data is transferred from one of four groups of memory arrays 210, depending on the state of array-address bits S[1:0], into the four lowest-numbered output buffers 215₀-215₃. Thus, referring to logic table 250 of FIG. 3, when S[1:0]=‘00’, the decode logic 225 enables tri-state drivers A₀-A₃ to transfer read data from a first group of four memory arrays 210₀-210₃ to the four output buffers 215₀-215₃. Similarly, when S[1:0]=‘01’, the decode logic 225 enables tri-state drivers B₀-B₃ and G₀-G₃ to transfer read data from a second group of four memory arrays 210₄-210₇ to output buffers 215₀-215₃; when S[1:0]=‘10’, the decode logic 225 enables tri-state drivers E₀-E₃ to transfer read data from a third group of four memory arrays 210₈-210₁₁ to output buffers 215₀-215₃; and when S[1:0]=‘11’, the decode logic 225 enables tri-state drivers F₀-F₃ and G₀-G₃ to transfer read data from a fourth group of four memory arrays 210₁₂-210₁₅ to the output buffers 215₀-215₃. Although a number of the memory array-to-output buffer paths includes two series-coupled tri-state drivers (i.e., in the case of memory arrays 210₄-210₇ and 210₁₂-210₁₅), in at least one embodiment, the additional data path delay that results from the increased number of tri-state drivers does not extend beyond the output buffer strobe assertion time used in the x16 and x8 modes, so that the same output buffer strobe assertion time (and therefore the same output enable assertion time) may be used in the x4 mode as in the x16 and x8 modes.

In the x2 mode, data is transferred from one of eight pairs of memory arrays 210 into the two lowest-numbered output buffers 215₀-215₁ in a two-phase transfer. In the first phase, data from the selected memory array pair (i.e., memory arrays 210₀-210₁, 210₂-210₃, 210₄-210₅, 210₆-210₇, 210₈-210₉, 210₁₀, 210₁₁, 210₁₂-210₁₃ or 210₁₄-210₁₅ according to whether S[2:0]=‘000’, ‘001’, ‘010’, ‘011’, ‘100’, ‘101’, ‘110’, or ‘111’, respectively) is transferred into selected pair of the four lowest-numbered output buffers 215₀-215₃. More specifically, if the selected memory array pair is coupled to tri-state driver network 207₀ or 207₁, (i.e., memory arrays 210₀-210₁, 210₄-210₅, 210₈-210₉ or 210₁₂-210₁₃), the read data is transferred to output buffers 215₀ and 215₁ (i.e., passing through multiplexers M₀ and M₁ via signal paths P0 and P1, respectively), whereas if the selected memory array pair is coupled to tri-state driver network 207₂ or 207₃ (i.e., memory arrays 210₂-210₃, 210₆-210₇, 210₁₀-210₁₁, or 210₁₄-210_{15,} the read data is transferred to output buffers 215₂ and 215₃.

In the second phase of the x2 output-width data transfer, data is transferred from the first-phase output buffers (either output buffers 215₀-215₁ or output buffers 215₂-215₃, depending on the address-selected pair of memory arrays) into output buffers 215₀-215₁. Note that, if the first-phase transfer resulted in the read data being loaded into output buffers 215₀-215₁, the data will be recirculated via a parallel output (po) of the output buffers 215₀-215₁ back through the multiplexers M₀ and M₁ (see the M₀ and M₁ selections of paths G0 and G1, respectively, in table 250 of FIG. 3) to parallel inputs of the output buffers 215₀-215₁, thus effecting a hold-state within the output buffers 215₀-215₁. As shown in FIG. 3, if read data was loaded into output buffers 215₂-215₃ in the first-phase transfer (i.e., if the selected pair of memory arrays is coupled to tri-state driver networks 207₂ or 207₃), multiplexers M₀ and M₁ are set to pass read data on the signal paths G2 and G3 (which are driven by tri-state output drivers J and K, respectively, based on the parallel outputs of output buffers 215₂-215₃) to output buffers 215₀-215₁. Thus, regardless of the selected pair of memory arrays, output buffers 215₀-215₁ will contain the desired read data after completion of the second-phase data transfer. Accordingly, the output enable signal may be asserted after the second phase of the two-phase x2-mode transfer is complete.

As with the x2 output width, the array-to-output buffer transfer in the x1 output-width configuration (x1=1) is a two-phase transfer. In the first-phase transfer, one of the sixteen memory arrays 210₀-210₁₅ is selected by array-address bits S[3:0] to provide data, via the corresponding tri-state driver network 207, to the lowest-numbered output buffer coupled to the tri-state driver network 207. That is, if one of memory arrays 210₀, 210₄, 210₈ or 210₁₂ is selected, tri-state driver network 207₀ is configured to deliver the selected read data to output buffer 215₀ via signal path P0 and multiplexer M₀. Similarly, if one of memory arrays 210₁, 210₅, 210₉ or 210₁₃ is selected, tri-state driver network 207₂ is configured to deliver the selected read data to output buffer 215₁ via signal path P1 and multiplexer M₁. If one of memory arrays 210₂, 210₆, 210₁₀ or 210₁₄ is selected, tri-state driver network 207₂ is configured to deliver the selected read data to output buffer 215₂, and if one of memory arrays 210₃, 210₇, 210₁₁ or 210₁₅ is selected, tri-state driver network 207₃ is configured to deliver data the selected read data to output buffer 215₃.

In the second-phase of a x1-mode transfer, data from one of the four output buffers loaded in the first-phase transfer is transferred to the output buffer 215₀. More specifically, as shown in logic table 250 of FIG. 3, if output buffer 215₀ was loaded in the first-phase transfer (i.e., S[3:0]=0000, 0100, 1000 or 1100), multiplexer M₀ is enabled to pass the data on path G0 back to the parallel input of output buffer 215₀, thus effecting a data hold operation in output buffer 215₀. If output buffer 215₁ was loaded in the first-phase transfer (i.e., S[3:0]=0001, 0101, 1001 or 1101), multiplexer M₂ is enabled to pass the data on path G1 to path G4, and multiplexer M₀ is enabled to pass the data on path G4 to output buffer 215₀. If output buffer 215₂ was loaded in the first-phase transfer (i.e., S[3:0]=0010, 0110, 1010 or 1110), tri-state driver J is enabled to transfer the contents of output buffer 215₂ to path G2, and multiplexer M₀ is enabled to pass the data on path G2 to output buffer 215₀. Lastly, if output buffer 215₃ was loaded in the first-phase transfer (i.e., S[3:0]=0011, 0111, 1011 or 1111), tri-state driver K is enabled to transfer the contents of output buffer 215₃ to path G3, multiplexer M₂ is enabled to pass the data on path G3 to path G4, and multiplexer M₀ is enabled to pass the data on path G4 to output buffer 215₀. Thus, regardless of the memory array selected by array-address bits S[3:0], output buffer 215₀ will contain the desired read data at the conclusion of the second phase of the two-phase data transfer. Accordingly, the output enable signal may be asserted after the second phase of the two-phase x1-mode transfer is complete.

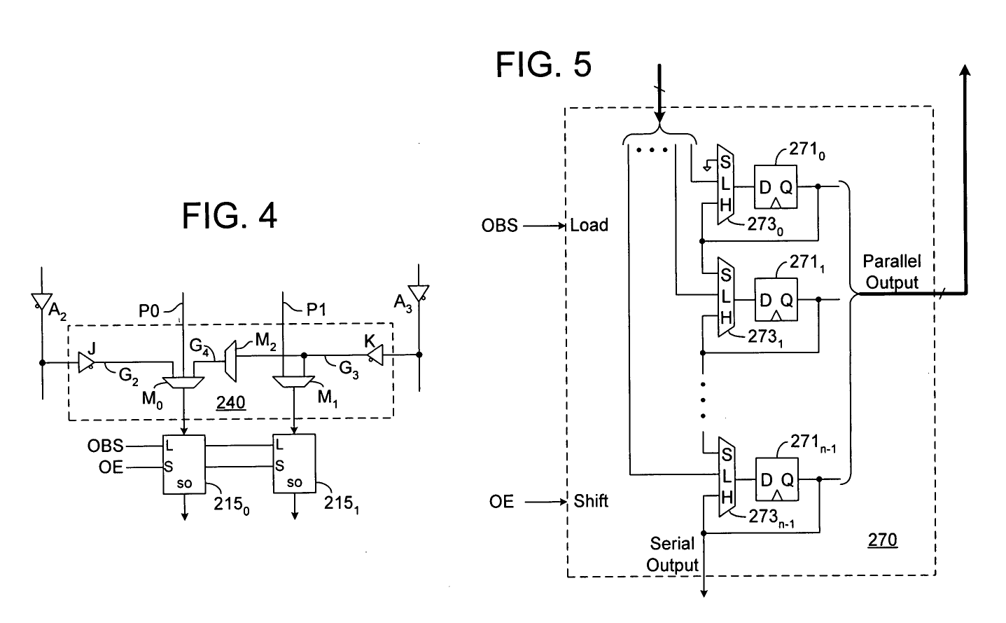

Reflecting on the two-phase transfers in the x1 and x2 output-width configurations, it can be seen that the output buffer strobe signal is asserted twice, once at the end of the first transfer-phase to capture the read data at an en-route location (i.e., one of the output buffers used to source data to loaded into the final output buffer) and again at the end of the second transfer-phase to capture the read data in the final output buffer. Thus, in the timing diagram of FIG. 1B, the output buffer strobe may be asserted once per read operation (i.e., at time T3_{A}) in the x16, x8 and x4 modes, and twice per read operation (at times T3_{A} and T3_{B}), in the x2 and x1 modes (as discussed, the timing interval between the two assertions of the output buffer strobe may differ from that shown in FIG. 1B). In an alternative embodiment, illustrated in FIG. 4, a single-phase transfer may be used in the x2 and x1 modes, with tri-state drivers J and K of narrow-path selector 240 being used to deliver data directly to the final output buffer (215₀ or 215₁) without intermediate latching. In such an embodiment, the parallel outputs of output buffers 215₀-215₃ need not be coupled to the narrow-path selector, and the output buffer strobe signal need be asserted only once per read operation to load the read data into the desired output buffer, regardless of the programmed output width. In such an embodiment, the presence of three tri-state drivers in series (e.g., tri-state driver combinations B₂-G₂-J, F₂-G₂-J, B₃-G₃-K and F₃-G₃-K) in combination with the increased RC delay that results from the longer signal path may cause the total data path delay to extend beyond the output buffer strobe assertion time used with the x16, x8 and x4 output widths. Accordingly, when the x2 or x1 output widths are selected, the output buffer strobe assertion time may delayed by a predetermined interval (i.e., sufficient to allow the read data to settle at the input of the desired output buffer). That is, as shown in FIG. 1B, the output buffer strobe may be asserted once per read operation: at time T3_{A} when the x16, x8 or x4 output width is selected, and at time T3_{B} when the x2 or x1 output width is selected.

FIG. 5 illustrates an exemplary output buffer 270 that may be used to implement the output buffers 215 of FIG. 2. The output buffer 270 includes a set of storage elements 271₀-271ₙ₋₁ (edge-triggered flip-flops in the embodiment shown, though latches or other types of storage elements may alternatively be used) and a corresponding set of multiplexers 273₀-273ₙ₋₁. The storage elements 271 are coupled to receive a clock signal (not shown) such as the clock signal, CLK, of FIG. 1 or a derivative thereof. The clock signal may include multiple component clock signals (e.g., differential clock pair, quadrature clocks or the like) to enable data to be loaded into the storage elements 271 at various times within a clock cycle.

The output buffer 270 also includes a load input to receive an output buffer strobe (OBS) and a shift input to receive an output enable signal (OE), and a logic circuit (not shown) which, in the embodiment of FIG. 5, outputs a control signal to the multiplexers 273 in accordance with the following table:

TABLE 1

| OE | OBS | Mux Selection |
|---|---|---|
| 0 | 0 | H (Hold) |
| 0 | 1 | L (Load) |
| 1 | X | S (Shift) |

By this arrangement, when the output buffer strobe and output enable are both low, the contents of each storage elements 271 is recirculated from its output to its input, thus effecting a data hold operation. When the output buffer strobe is asserted (e.g., to a logic ‘1’) and the output enable signal held low, read data is loaded into each of the storage elements 271 in parallel. When the output enable signal is raised, the output buffer 270 operates as a shift register, shifting read data forward within the storage elements 271 (i.e., progressing toward storage element 2711ₙ₋₁) to present a new data value at the serial output. It should be noted that the hold state achieved when the output buffer strobe and output enable are both low may be used to effect the hold operation described in reference to paths G0 and G1 and corresponding inputs to multiplexers M₀ and M₁, thus enabling the G0 and G1 paths and corresponding multiplexer inputs to be omitted from the memory device 200. Also, in an alternative embodiment of output buffer 270, instead of using multiplexers 273 to select between load and hold conditions, the clock signal used to clock the storage elements 271 may be gated by the output buffer strobe.

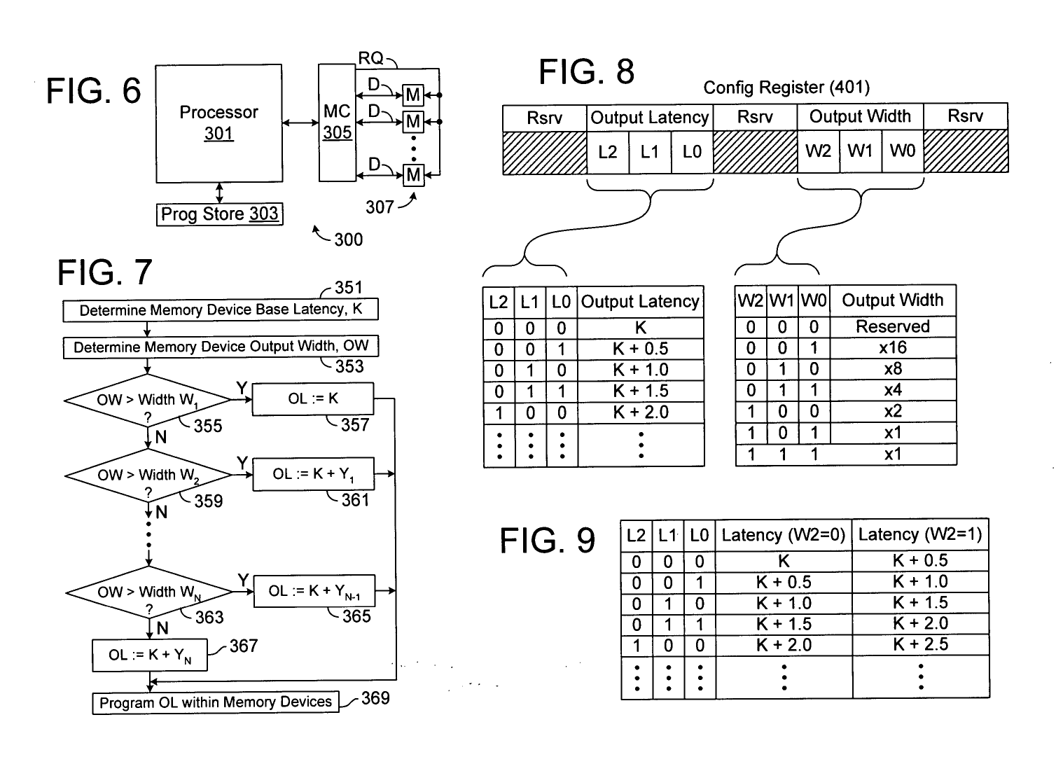

FIG. 6 illustrates an exemplary data processing system 300 having a processor 301, program storage 303, memory controller 305 and a number of memory devices 307 (M) each having a width-dependent output latency according to embodiments described above. In one embodiment, the program storage 303 is implemented by one or more non-volatile storage devices such as a flash EEPROM, magnetic or optical storage or other storage type in which program code (including, for example, instructions and non-transient data as may be included in basic input-output service (BIOS) program code) may be stored and retained after system power down. At system startup, the processor 301 executes one or more sequences of instructions stored in the program storage 303 to initialize other components of the data processing system 300 including, for example, issuing memory access requests and memory configuration requests to the memory controller 305. The memory controller 305, in turn, issues access requests and configuration requests to the memory devices 307 via request path RQ and/or data paths, D. In the particular embodiment shown, the request path is coupled in parallel to request interfaces of each of the memory devices 307 (thus forming a multi-drop bus), while the data paths are formed by respective sets of point-to-point links between the memory controller 305 and memory devices 307. In an alternative embodiment, the request path may be implemented by a set of point-to-point links and/or the data paths may be formed by one or more multi-drop buses. For example, in one embodiment, the memory devices 307 are disposed on a set of memory modules (e.g., single inline memory modules (SIMMs) or dual inline memory modules (DIMMs)) with a separate request path being coupled to each memory module (i.e., each request path coupled in parallel to the memory devices on the module) and with separate data paths being coupled in a multi-drop configuration to memory devices on respective modules. As a more specific example, in a system having two memory modules bearing N memory devices each, two request paths may be coupled respectively to the two memory modules and N data paths may be coupled to respective pairs of memory devices, with each pair of memory devices including one memory device on the first memory module and another memory device on the second memory module. It should be noted that the data processing system may additionally include numerous other components not shown in FIG. 6 including, without limitation, additional processors (e.g., graphics processor), memories, user interface devices, network communication devices, bus bridges and/or peripheral devices. Also, two or more components within the data processing system 300 may be combined into a single integrated circuit die or in an integrated circuit package containing multiple die, as for example, in the case of a processor having an integrated memory controller function, or a system-in-package DRAM in which the processor, memory controller and/or one or more DRAM devices are combined in a single integrated circuit package. The data processing system 300 may be used within a variety of computing systems including, without limitation, general-purpose computing systems, and embedded computing systems applied, for example, within a network communications device such as a switch or router, or within a consumer electronics device such as a cell phone, personal digital assistant (PDA), camera, media player, etc.

FIG. 7 illustrates an exemplary sequence of operations that may be carried out by the programmed processor 301 of FIG. 6 to program the output width and output latency of the memory devices 307. Initially, at block 351, the processor determines the base latency, K, of the memory devices, for example, by retrieving information associated with the memory devices (e.g., by reading a serial presence detect (SPD) component included on a memory module with the memory devices or reading characterizing information from the memory devices themselves) or by reference to a value recorded within the program storage 303. In a specific embodiment, for example, the processor (or memory controller) reads the column access time parameter of the memory device (i.e., time to output data measured from receipt of the column address), divides the column access time parameter by the period of the clock, then, if necessary, rounds up the result to an integer value. By this operation, the column access time parameter is converted from a value expressed in nanoseconds to a value expressed in clock cycles, thus providing the base latency value, K, in terms of clock cycles of the clock signal. At block 353, the processor determines an output width, OW, to be programmed within each of the memory devices. The output width may also be determined by retrieving information associated with the memory devices which directly or indirectly indicates the desired output width. For example, in one embodiment, the processor determines the output width by retrieving information that indicates the number of memory devices coupled to the memory controller (e.g., retrieving from a serial presence detect or other non-volatile storage associated with the memory devices), then computes the output width by dividing the total number of controller-to-device signaling links by the number of memory devices (e.g., if the system includes 256 point-to-point signaling links and 32 memory devices, a device output width (OW)=256/32=8 may be computed).

At decision block 355, the processor compares the output width determined in block 353 with a first threshold width, W₁. If the output width is greater than W₁, then an output latency value (OL) is assigned the base latency, K at block 357 (i.e., OL:=K). If the output width less than or equal to the threshold width W₁, the output width is compared with a second threshold width, W₂, at decision block 359. If the output width is greater than W₂, then at block 361 the output latency value is assigned the base latency, K, plus an additional time, Y₁, sufficient to account for the additional data path delay in the narrower output width. If the output width is less than or equal to W₂, then the output width may be compared with any number of additional width thresholds (with correspondingly incremented output latencies being assigned if greater than the width thresholds) before being compared with a final width threshold W_{N} at block 363. If the output width is greater than W_{N}, then at block 365 the output latency is assigned the base latency, K, plus an additional time, Y_{N-1}, sufficient to account for the additional data path delay in the narrower output width. If the output width is less than or equal to W_{N}, then at block 367, the output latency is assigned the base latency plus an additional time, Y_{N}, sufficient to account for the additional data path delay in the narrowest output width.

After the output latency value has been assigned, the output latency is programmed within the memory devices at block 369, for example, by processor-issued request to the memory controller 305 and corresponding request or requests issued by the memory controller 305 to the memory devices 307. It should be noted that while a generalized number of width-threshold comparisons and output latency assignments are shown in FIG. 7, a single width-threshold comparison may be made in a particular embodiment, with one of two output latency values being programmed within the memory devices according to whether the output width exceeds the threshold. Also, rather than assigning an actual time value to the output latency value, OL, a code that corresponds to the desired output latency may be assigned to OL and programmed within the memory devices. Further, while not specifically shown in FIG. 7, the output width of the memory devices may be programmed before or after programming the output latency. Also, the memory devices may be programmed with different output widths as desired to establish an overall data transfer width between the memory controller 305 and memory devices 307 of FIG. 6. In such an embodiment, the output latency value to be programmed within each of the memory devices may be determined in accordance with the narrowest programmed output width. Also, different output latencies may be programmed within different memory devices 307, for example, to compensate for flight time differences between the data paths coupled between the memory controller 305 and memory devices 307. In other embodiments, the output latency need not be explicitly programmed within the memory devices 307, but rather is established within the memory devices according to their programmed output widths. In such embodiments, circuitry otherwise used to support explicitly programmable output latency may be omitted from the memory devices 307. Also, the memory controller 305 may automatically adjust its returned-data sampling time (the time at which the memory controller expects to receive read data in response to a read request) based on the output width programmed within the memory devices 307.

FIG. 8 illustrates an exemplary configuration register 401 that may be included within the memory devices 307 of FIG. 6 or other memory devices described herein to enable output latency and output width programming. In the particular embodiment shown, the output width and output latency are represented by respective fields of three bits each within the configuration register. Larger or smaller fields of bits may be used to accommodate the desired number of output widths and output latencies in a given application. Also, as discussed above, separate registers (or other types of storage circuits) may be used to store the output latency and output width, and any number of other control values may be recorded within the configuration register 401 to establish a desired configuration and/or operating mode within the host memory device.

Each of the different three-bit output-latency codes (or a subset thereof if there are less than eight desired programmable output latencies) programmed within the configuration register 401 corresponds to a different output latency, shown generally, in FIG. 8 by the expression “K+n”, where K is the minimum output latency of the memory device and ‘n’ represents the incremental latency over the base latency (e.g., 0.5, 1.0, 1.5, 2.0) expressed in clock cycles or other time-based units. Similarly, each of the different three-bit output-width codes corresponds to a different device output width. In the particular embodiment shown, five codes are assigned to the widths x16, x8, x4, x2 and x1 , with the other codes being reserved. As discussed above, more or fewer width codes corresponding to a subset or superset (or partially or entirely different set) of the output widths shown in FIG. 8 may be used in alternative embodiments.

In the embodiment of FIG. 8, the programmed output latency is used to control the timing of output enable signal assertion within the memory device regardless of the programmed output width. Accordingly, in such an embodiment, the memory controller or programmed processor may be programmed to account for the incremental data path delay by programming a longer output latency if the desired output width is less than a threshold width (e.g., as generally described in reference to FIG. 7). In an alternative embodiment, illustrated in FIG. 9, the memory device itself may automatically account for output widths that increase the output latency of the memory device. Thus, as shown, if the most significant bit of the output width is clear (i.e., W2=0), then an output width of x16, x8 or x4 has been selected so that the selectable output latency ranges from the minimum output latency of the memory device, K, to a number of progressively higher output latencies. By contrast, if W2=1, then an output width of x2 or x1 (i.e., below the x4 threshold width) has been selected and the memory device automatically interprets the programmed output latency code as selecting an output latency that is incrementally higher than in the x16, x8 and x4 cases. In the particular embodiment shown, the increment is a half clock cycle, though a larger or smaller increment may alternatively be used.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

Although the invention has been described with reference to specific embodiments thereof, it will be evident that various modifications and changes may be made thereto without departing from the broader spirit and scope of the invention. Accordingly, the specification and drawings are to be regarded in an illustrative rather than a restrictive sense. In the event that provisions of any document incorporated by reference herein are determined to contradict or otherwise be inconsistent with like or related provisions herein, the provisions herein shall control at least for purposes of construing the appended claims.

What is claimed is:

1. A memory device comprising:
a memory core;
a plurality of output buffers;
a configuration circuit to store an output-width value;
a steering circuit to convey data from the memory core to the plurality of output buffers along a path indicated by the output-width value; and
control circuitry to strobe the data into the plurality of output buffers at a first time if the output-width value indicates a first device width and at a second, later time if the output-width value indicates a second device width.

2. The memory device of claim 1 wherein the control circuitry is configured to strobe the data into the plurality of storage buffers at both the first time and the second time if the output-width value indicates the second device width.

3. The memory device of claim 1 wherein memory core comprises a first plurality of memory arrays and wherein the steering circuit comprises:
a multiplexer having a first input coupled to an output node of a first output buffer;
a routing circuit to selectively route data from the first plurality of memory arrays to a plurality of output paths; and
a multiplexer having a first input coupled to one of the plurality of output paths, a second input coupled to an output of one of the output buffers and a multiplexer output coupled to an input of the one of the output buffers.

4. The memory device of claim 3 wherein the control circuitry is configured to output a select signal to the multiplexer to couple the first input to the multiplexer output at the first time and to couple the second input to the multiplexer output at the second time.

5. The memory device of claim 1 wherein the steering circuit is configured to convey data from the memory core to a selected set of the output buffers, the selected set of the output buffers including all the output buffers when the output-width value indicates a first device width, and fewer than all the output buffers when the output-width value indicates a second device width.

6. The memory device of claim 1 further comprising a plurality of output drivers coupled to the plurality of output buffers to output the data strobed into the plurality of output buffers onto an external data path.

7. The memory device of claim 6 wherein each output driver of the plurality of output drivers is coupled to receive data from a respective one of the plurality of output buffers and to output the data to a respective signaling link of the external data path, and wherein the control circuitry is configured to enable a selected set of the output drivers to output data onto the external data path, the selected set of the output drivers including all the output drivers when the output-width value indicates a first device width, and fewer than all the output drivers when the output-width value indicates a second device width.

8. The memory device of claim 1 wherein the control circuitry includes timing circuitry to assert a strobe signal at a first time when the output-width value indicates a first device width and to assert the strobe signal at a second, later time when the output-width value indicates a second device width, and wherein the data is loaded into the plurality of output buffers in response to assertion of the strobe signal.

9. The memory device of claim 1 wherein the memory core comprises a plurality of memory arrays, and wherein the steering circuit is responsive to a first setting of the output-width value to convey data from each of the memory arrays to a respective one of the output buffers.

10. The memory device of claim 9 wherein the steering circuit is further responsive to a second setting of the output-width value to convey data from an address selected subset of the memory arrays to a corresponding subset of the output buffers, the subset of output buffers being determined in accordance with the output-width value.

11. A method of controlling a memory device having a plurality of output drivers and a configuration circuit, the method comprising:
providing an output-width value to be stored in the configuration circuit to control the number of the output drivers that are to output data in response to a read request;
determining an output-latency value based, at least in part, on the output-width value; and
providing the output-latency value to be stored in the configuration circuit to control the amount of time that transpires before the output drivers are enabled to output data in response to the read request.

12. The method of claim 11 wherein providing the output-width value to be stored in the configuration circuit and providing the output-latency value to be stored in the configuration circuit comprise providing the output-width value and the output-latency value to be stored in a register within the configuration circuit.

13. The method of claim 11 wherein determining the output-latency value based, at least in part, on the output width value comprises:
selecting a first output-latency value from a plurality of output-latency values if the output-width value indicates a first device width; and
selecting a second output-latency value from the plurality of output-latency values if the output-width value indicates a second device width.

14. The method of claim 13 wherein determining the output-latency value based, at least in part, on the output width value comprises:
assigning a first value to be the output-latency value if the output-width value indicates that the number of the output drivers that are to output data in response to a read request is greater than a threshold number; and
assigning a second value to be the output-latency value if the output-width value indicates that the number of the output drivers that are to output data in response to a read request is less than the threshold number.

15. The method of claim 14 wherein the second value corresponds to a longer output latency than the first value.

16. The method of claim 11 further comprising determining the output width based, at least in part, on information that indicates a number of memory devices coupled to a memory controller.

17. The method of claim 16 wherein determining the output width based on information that indicates a number of memory devices comprises dividing a number of signal links available to transfer data between the memory devices and the memory controller by the number of memory devices.

18. The method of claim 16 further comprising retrieving at least part of the information that indicates a number of memory devices from a non-volatile storage disposed on a memory module.

19. A memory device comprising:
a plurality of output drivers;
a configuration circuit to store an output-width value that controls the number of the output drivers that are to output data in response to a memory read request, and to store an output-latency value that indicates an amount of time that is to transpire before the output drivers are enabled to output data in response to the read request; and
a control circuit to enable the plurality of output drivers to output data in response to the read request after delaying for a time interval determined in part by the output-latency value and in part by the output-width value.

20. The memory device of claim 19 wherein the configuration circuit comprises at least one register to store the output-width value and the output-latency value.

21. The memory device of claim 19 wherein the memory device comprises a clock input to receive a clock signal and wherein minimum amount of time indicated by the output-latency value is a minimum number of cycles of the clock signal.

22. The memory device of claim 21 wherein the minimum number includes a fractional value.

23. The memory device of claim 19 wherein the time interval is the minimum amount of time indicated by the output-latency value if the output-width value indicates that more than a threshold number of the output drivers are to output data in response to a memory read request, and the time interval is greater than the minimum amount of time if the output-width value indicates that fewer than the threshold number of the output drivers are to output data in response to a memory read request.

24. Computer readable media having information embodied therein that includes a description of an apparatus, the information including descriptions of:
a plurality of output buffers;
a configuration circuit to store an output-width value;
a steering circuit to convey data from the memory core to the plurality of output buffers along a path indicated by the output-width value; and
control circuitry to strobe the data into the plurality of output buffers at a first time if the output-width value indicates a first device width and at a second, later time if the output-width value indicates a second device width.

25. A system comprising:
means for programming an output-width value within a memory device to control the number of the output drivers that are to output data from the memory device in response to a read request;
means for determining an output-latency value based, at least in part, on the output-width value; and
means for storing the output-latency value within the memory device to control the amount of time that transpires before the output drivers are enabled to output data in response to the read request.
